(19) United States
(12) Patent Application Publication
(10) Pub. No.: US 2010/0226224 A1
(43) Pub. Date: Sep. 9, 2010

(54) DISC DRIVE AND PHOTO-DETECTOR GAIN SELECTION METHOD

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/294,261

(22) PCT Filed: Mar. 28, 2007
(86) PCT No.: PCT/IB07/51092

§ 371 Date: Sep. 24, 2008

(30) Foreign Application Priority Data
Mar. 29, 2006 (EP) 06111937.6

(51) Int. Cl. G11B 20/10

(52) U.S. Cl. 369/47.25; G9B/20.009

(57) ABSTRACT

The present invention relates to a method of selecting a range of gain values (2000) of a gain-bandwidth limited photo-detector circuit (45) for reading data from a record carrier (104). The method comprises: a) finding a first read power by setting a maximum allowable gain value (gmaχ), the first read power being a minimum read power value at which data is readable from the rotating record carrier at a first speed; and b) finding a second read power and a second gain value, by increasing the first read power value and decreasing the maximum allowable gain value. The second read power being the minimum read power value at which data is readable from the rotating record carrier at a second speed. The method is useful for all kinds of photo-detector circuits in optimizing gain values and achieving optimum performance with the optimum number of gain values.

The invention relates to optical disc drives and more specifically to photo-detector circuits of optical drives.

Kaneko Shinji et.al in their patent document JP06096449 teach a method of operating a variable gain type photo-detector circuit suitable for use in a disc drive. Their method comprises switching between two gain values, so that data can be read from different discs, namely a Read Only Memory (ROM) disc and a Write Once (WO) disc, having different reflectivity values. Their method selects the gain value based on the type of the disc. Kaneko Shinji's method requires that each disc type and subtype have its own gain value, e.g. BD-R/RE DL, BD-R/RE SL, BD-ROM SL, BD-ROM DL. This increases the range of gain values and makes the gain selection circuitry complex (e.g. digital-to-analog converter) and expensive.

It would be advantageous to have a method that allows a worst-case disc (in terms of signal level) to be read at the maximum possible speed, keeping the range of gain values in the photo-detector circuit at the optimum. It would also be advantageous to have a gain selection device that allows a worst-case disc to be read at the maximum possible speed, keeping the range of gain values in the photo-detector circuit at the optimum. It would also be advantageous to have a computer program code means that allows a worst-case disc to be read at the maximum possible speed, keeping the range of gain values in the photo-detector circuit at the optimum.

Accordingly, a method of selecting a range of gain values of a gain-bandwidth limited photo-detector circuit for reading data from a record carrier is described herein. A first read power is found by setting a maximum allowable gain value from a plurality of allowable gain values of the photo-detector circuit. The first read power is a minimum read power value at which data is readable from the record carrier, while the record carrier is rotating at a first speed. A second read power and a second gain value is found by increasing the first read power value and decreasing the maximum allowable gain value. The second read power is a minimum read power value at which data is readable from the record carrier, while the record carrier is rotating at a second speed. The method achieves the selection of gain values by reserving the highest gain value allowable by the photo-detector circuit to read the worst-case record carrier at the lowest speed, and decreasing the gain value at higher speed for this record carrier. By doing this, the reduction of the signal level is compensated by an increase in read power.

Further, a gain selection device for selecting a range of gain values of a gain-bandwidth limited photo-detector circuit for reading data from a record carrier is described herein. A first read power finding means finds a first read power by setting a maximum allowable gain value from a plurality of allowable gain values of the photo-detector circuit. The first read power is a minimum read power value at which data is readable from the record carrier, while the record carrier is rotating at a first speed. A second read power-second gain value finding means finds a second read power and a second gain value by increasing the first read power value and decreasing the maximum allowable gain value. The second read power is a minimum read power value at which data is readable from the record carrier, while the record carrier is rotating at a second speed.

Further, a computer program code means for selecting a range of gain values of a gain-bandwidth limited photo-detector circuit for reading data from a record carrier is described herein. This is particularly, but not exclusively, advantageous in that the present method may be implemented by a computer program code means enabling a computer system to perform the operation of gain selection. Thus, it is contemplated that some known optical drive may be changed to operate according to the method described here by installing a computer program code means on a computer system controlling the said optical drive. Such a computer program code means may be provided on any kind of computer readable medium, e.g. magnetic or optical based medium.

These and other aspects, features and advantages of the invention will be further explained by the following description, by way of example only, with reference to the accompanying drawings, in which same reference numerals indicate same or similar parts, and in which:

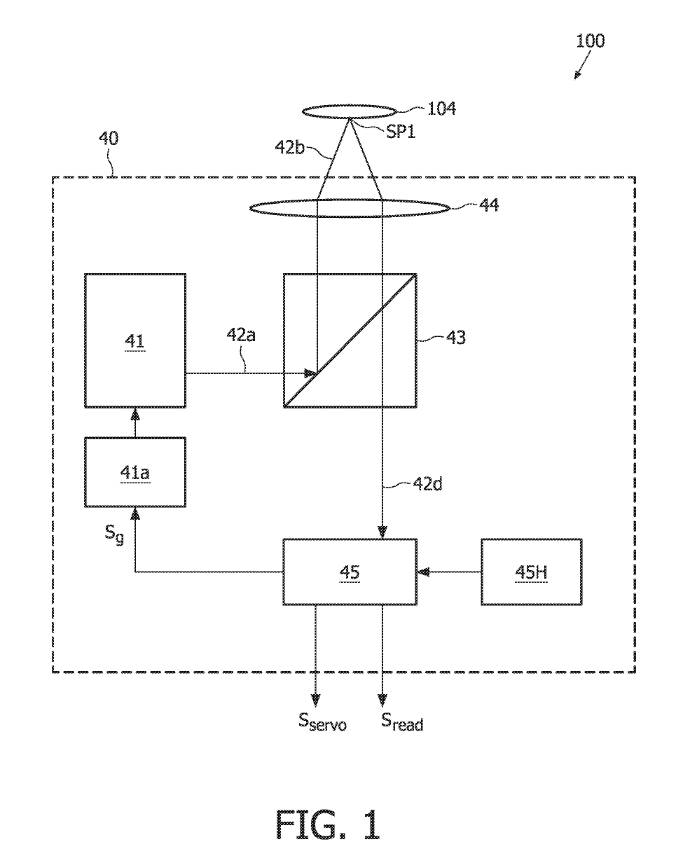

FIG. 1 schematically illustrates an optical disc drive; and

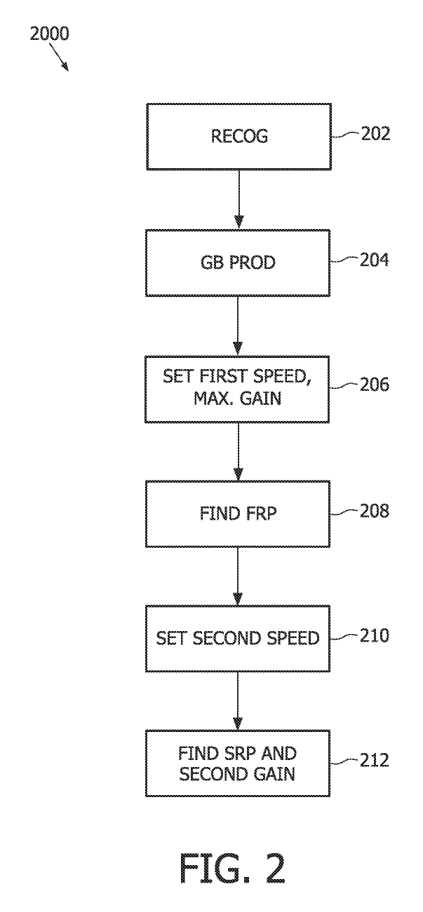

FIG. 2 is a flow chart illustrating the steps of the method of selecting a range of gain values of a photo-detector circuit.

In FIG. 1, a drive device 100 for reading information from an optical disc 104, typically a Blu-ray disc, is shown. The disc drive 100 includes a motor (not shown) for rotating the optical disc 104 and an optical system 40 for scanning tracks of the optical disc 104 by an optical beam. More specifically, the optical system 40 includes light beam generator means 41, e.g. a laser such as a laser diode, arranged to generate a light beam 42a. A light driving circuit 41a drives the light beam generator means 41. The light beam 42a passes a beam splitter 43 and an objective lens 44. The objective lens 44 focuses the light beam 42b on to a spot SP₁ on the optical disc 104. The light beam 42b reflects from the optical disc 104 and passes the objective lens 44 and the beam splitter 43 to reach an optical detector 45. The optical detector 45 comprises a plurality of detector segments, e.g. four detector segments, 45a, 45b, 45c, 45d capable of providing individual detector signals A, B, C, D respectively, indicating the amount of light incident on each of the four detector quadrants respectively. One example of an optical detector 45 is a ten-channel photo-detector integrated circuit SP8059 from SIPEX. SP8059 is designed for new generation of Blu-ray, DVD and CD applications. It can operate at wavelengths of 405, 650 and 780 nm and suitable for 4x Blu-ray Read/Write, x16 DVD Read/Write and x48 CD Read/Write. The ten channels consist of four high-speed channels, four slow channels and two RF channels.

The light beam 42d enters the optical detector 45, and is converted into an electrical signal, and amplified before a signal reproduction is carried out. The optical detector 45 outputs a signal S_{g}. The signal S_{g} enters the light driving circuit 41a and adjusts output light power of the light beam generator means 41. The optical detector circuit 45 includes an amplifier. The output of the optical detector 45 is supplied to a first differential amplifier (not shown) and a second differential amplifier (not shown). The output signal of the first differential amplifier Sₛₑᵣᵥₒ is used for focussing servo and tracking servo of the optical system 40. The output signal of the second differential amplifier S_{read} is used to read out signal information written on the optical disc 104. Different optical discs have different reflectance, and the quantity of reflected light from the disc varies between the different types of discs. For ensuring robust reading of data stored on an optical disc, it is required to generate a readout signal that is of good quality. Data recovery becomes difficult if the input readout signal is of low amplitude. In order to accommodate this difference in light input level, the optical detector 45 is provided with a gain setting means to set the gain of the amplifier accordingly. This enables the gain to be set suitably for reading a low reflective disc and a high reflective disc at various speeds, thereby obtaining a desirable readout signal for each disc. The gain values can be set as 1x, 2x, 3x, 4x, etc. To this end, the drive device 100 comprises a gain selection device 45H. The gain selection device 45H selects an optimum number of gain values to be set. The gain selection device 45H comprises first read power finding means and second read power-second gain value finding means.

Optical discs are produced in many types (single and dual layer) such as CD-DA, DVD-Video, DVD-ROM, DVD+RW, Blu-ray R/RE, and Blu-ray ROM. The disc drive has to support these different disc types at different speeds. The product of gain and bandwidth of the photo-detector circuit limits the readout speed. The bandwidth is usually set per disc type (CD, DVD, BD) and per speed (1x, 2x, . . . 4x etc). For CD, the bandwidth is typically 1.5 MHz at a speed of 1x, for DVD, the bandwidth is typically 9 MHz at a speed of 1x, and for BD, the bandwidth is typically 20 MHz at a speed of 1x. The photo-detector circuit has to cater to: i) different types of optical discs ii) different speeds iii) different reflectivity values iv) the limitation of gain-bandwidth product of the photo-detector circuit. Hence, the photo-detector circuit allows a range of gain values. The faster reading speed and diversification of optical discs has created a situation where the photo-detector circuit receives a small optical signal when reproducing a low-reflective disc and there is difficulty in reproducing signals from such low-reflective discs. The combination of low disc reflection, a low returning efficiency in the optical pick up unit (OPU), and a low photo-detector circuit efficiency leads to low current levels produced by the photo-detector circuit. In order to have an acceptable signal level, at the output of the photo-detector circuit, a large gain is required. This will limit the bandwidth of the readout signal. A worst-case disc that has very low signal level at the photo-detector circuit may require a large gain. A method of selecting a range of gain values of the optical detector 45 using the gain selection device 45H for reading data from the optical disc 102 is described herein with reference to FIG. 2.

In step 202, the optical disc 104 from which data is to be read is recognized. There are prior art optical disc recognition methods available that can be made use of to recognize the type of the optical disc. The type of the optical disc, for example, can be one of (but, not limited to) BD-R/RE SL, BD-R/RE DL, BD-ROM SL, BD-ROM DL, CD-R, CD-RW, CD-ROM, DVD-ROM, DVD-RAM, DVD-R or DVD-RW. It is important to recognize the type of the disc inserted in the drive device 100. More recently, disc drives have been developed which are capable of handling two or more different types of disc. Such a type of drive device 100 is called as multiple-type drive. Since a multiple drive type may expect a disc to be any of two (or more) different types of disc, the disc drive needs to ascertain the type of the disc when a new disc is inserted, in order to be able to handle the disc with the correct format. After the type of the disc is recognized, the drive device 100 uses an appropriate laser source with a specific wavelength to read data from the disc. As an example, U.S. Pat. No. 6,061,318 discloses a method for discriminating disc type on the basis of thickness of the disc, which can be used to recognize the type of the disc. In step 204, a gain-bandwidth product of the optical detector 45 is obtained. The gain-bandwidth product will be a constant number, e.g. 100. The gain-bandwidth product gives a minimum allowable gain value gₘᵢₙ, e.g. 1x, a maximum allowable gain value gₘₐₓ, e.g. 5x, a minimum allowable bandwidth, e.g. 20 MHz and a maximum allowable bandwidth, e.g. 100 MHz. In step 206, the speed of the drive device 100 is set to a first speed allowable by the optical drive 100 for reading the optical disc 104. The gain value is set to the maximum allowable gain value gₘₐₓ and the bandwidth is set to the minimum allowable bandwidth. With these settings, in step 208 data is read from the optical disc 104 and a first read power is obtained. First read power is the minimum read power value at which data is readable from the optical disc 104, while the optical disc 104 is rotating at the first allowable speed. In step 210, the speed of the drive is set to a second speed allowable for reading the optical disc 104. In step 212, a second read power and a second gain value is found. The second read power is found by decreasing the maximum gain value gₘₐₓ and increasing the first read power value. The first read power value is increased up to the maximum allowable read power value Rₘₐₓ, where Rₘₐₓ is the maximum read power allowable for reading the optical disc 104 at the maximum allowable speed. The maximum gain value gₘₐₓ is decreased up to the minimum allowable gain value gₘᵢₙ. This is made clear with a pseudo code representation, which is given below:

for (i=gₘₐₓ; i<=gₘᵢₙ; i−−)

for (j=FRP; j<=Rₘₐₓ; j++)

{If data from optical disc is readable, then

second gain value=i;

second read power=j;}

In one possible embodiment, the second speed allowable by the drive device 100 is higher than the first speed allowable by the drive device 100. The first speed is set to a lowest speed, e.g. 1x and the second speed is set to a highest speed, e.g. 4x. This is advantageous so that maximum speed for a worst-case (in terms of signal level) optical disc 104 is realized and the worst-case disc that is having a low reflective value can be read at the highest speed. This guarantees that a worst-case disc can be read at the maximum possible allowable speed. In general, the highest data transfer rate is obtained at the highest rotation speed of the disc. Therefore, the application will always aim at the highest possible speed for a certain disc type. Because not all disc types allow the highest speed, the drive device must support multiple speeds in order to cover all supported media at the maximum transfer rate.

In another possible embodiment of the method, the second read power and the second gain value is found on the basis of: i) the allowable gain-bandwidth product of the photo-detector circuit ii) a maximum allowable read power Rₘₐₓ for the optical disc 104. In this way a maximum data transfer rate is obtained for the given photo-detector circuit and the given disc standard. Each disc depending upon the disc standard, allows a certain read power to be used for reading a disc. In case the read power value is exceeded, there is a possibility of damaging the disc. E.g. the maximum allowable read power for Blu-ray disc at 4x speed is 1.2 mW. By restricting this read power, the possible damage to the disc is overcome. Further, the gain-bandwidth product limits bandwidth of the readout signal. Considering the gain-bandwidth product and selecting gain values assures that the disc drive 100 is operated within the allowable bandwidth limits.

Table 1 schematically illustrates a possible result of the proposed method for selecting a range of gain values of the photo-detector circuit for reading data from a Blu-ray disc 104. The reason for selecting a Blu-ray disc is that, for CD and DVD, the signal-to-noise ratio is not so critical, and noise prohibits a high readout speed. Mechanical considerations like motor and drive dissipation limit the maximum obtainable disc speed. For Blu-ray disc, the signal-to-noise ratio is particularly critical because in general the disc's reflectivity is much lower, and moreover the returning efficiency and detector efficiency of the optical path are much lower than for CD and DVD. It is assumed that the allowable gain-bandwidth product of the photo-detector circuit 45 is 80 MHz. It is assumed that the bandwidth required for a speed of 1x readout equals 20 MHz. Four types of Blu-ray discs are considered here namely: a) BD-R/RE DL—Read, Rewritable dual layer b) BD-R/RE SL—Read, Rewritable single layer c) BD-ROM DL—Read Only Memory dual layer d) BD-ROM SL—Read Only Memory single layer. In the example considered for illustration, the minimum speed allowable by the BD drive is 2x, and the maximum speed allowable by the BD drive is 4x.

It can be observed from table 1 that the disc BD-R/RE DL is the worst-case disc. This is the worst-case disc, since it produces the lowest photo-detector signal, i.e. (0.6×5)/100=0.03. For this disc BD-R RE/DL, at 2x speed, (minimum speed) the gain value is set at the maximum gain value gₘₐₓ, i.e. 2x, which limits the bandwidth to 40 MHz. The read power for this disc is limited to 0.6 mW by the Blu-ray disc standard. At 4x speed, (maximum speed) the read power is increased up to the maximum read power value allowable by the 4x standard and the gain is decreased accordingly, with a factor of 2. This yields the required bandwidth of 80 MHz. It can be observed from table 1 that the other disc types are less critical, i.e. the product of the allowed P_{read} and the disc reflection is larger for them than for BD-R RE/DL, i.e. 0.06. The read power for these discs is chosen such that at 1x gain the signal levels are the same as for BD-R RE/DL at 4x speed. For example, for the disc BD-R/RE SL at 2x speed, the read power is selected as

$${P}_{read} = \frac{\begin{matrix}( {P}_{read} ) \times ( Disc reflection ) of \\ BD \text{-} R / RE DL at 4 x speed\end{matrix}}{( \begin{matrix}Disc reflection of \\ BD \text{-} R / RE SL at 2 x speed\end{matrix} )}$$

$$which is$$

$$\begin{matrix} = ( 1.2 \times 0.05 ) / 0.15 \\ = 0.4 mW .\end{matrix}$$

On similar lines the read powers for other discs are selected, namely 0.4, 0.4, 0.4, 0.15, and 0.15. This means that all BD discs can be read at 1x . . . 4x speeds using only two gain values, i.e. 1x and 2x. Furthermore, with these two gain values, it is possible to fit all other discs that are not worst-case discs with these two gain values by using an appropriate read power, as long as the limitation in gain-bandwidth product of the photo-detector circuit is not exceeded. From this, it is clear that the present invention allows many more optical discs to be read using two gain values, by appropriately choosing the read power values. This is one way of implementing the invention. Table 1 illustrates only an example of the method of selecting a range of gain values of the photo-detector circuit for reading data from a BD disc, and a possible result where BD-R RE DL is the worst-case disc. This need not be the case always. It is to be noted that, based on the disc reflection, P_{read}, and other factors, the results will vary.

In essence, the read powers and gains are chosen such that the maximum possible speed for a disc is realized, taking into account the photo-detector circuits gain-bandwidth product, the allowable read power according to the disc standard while minimizing the number of gain values in the photo-detector circuit.

TABLE 1

| Disc type | Speed | Pread [mW] | Reflection | Gain | BW [MHz] |
|---|---|---|---|---|---|
| BD-R/RE DL | 2x | 0.6 | 5% | 2x | 80 |
| BD-R/RE DL | 4x | 1.2 | 5% | 1x | 80 |
| BD-R/RE SL | 2x | 0.4 | 15% | 1x | 80 |
| BD-R/RE SL | 4x | 0.4 | 15% | 1x | 80 |
| BD-ROM DL | 2x | 0.4 | 15% | 1x | 80 |
| BD-ROM DL | 4x | 0.4 | 15% | 1x | 80 |
| BD-ROM SL | 2x | 0.15 | 40% | 1x | 80 |
| BD-ROM SL | 4x | 0.15 | 40% | 1x | 80 |

Although the invention has been explained by embodiments using optical discs, the invention is also suitable for other record carriers such as rectangular cards or any other type of information carrier that uses a light source and a photo-detector circuit for reading data from the rotating record carrier. A person skilled in the art can implement the described embodiments of the method of selecting a range of gain values of photo-detector circuit in software or in both hardware and software. It will, however, be evident that various modifications and changes may be made without departing from the broader scope of the invention, as set forth in the appended claims. Use of the verb “comprise” does not exclude the presence of elements other than those stated in a claim or in the description. Use of the indefinite article “a” or “an” preceding an element or step does not exclude the presence of a plurality of such elements or steps. The Figures and description are to be regarded for illustrative purposes only and do not limit the invention.

In summary, a method of selecting a range of gain values of a gain-bandwidth limited photo-detector circuit for reading data from a record carrier is described herein. The record carrier is rotatable at a plurality of allowable speeds by a drive device. The method comprises:

finding a first read power (FRP) by setting a maximum allowable gain value (gₘₐₓ) from a plurality of allowable gain values of the photo-detector circuit, the first read power (FRP) being a minimum read power value at which data is readable from the record carrier, while the record carrier is rotating at a first speed allowable by the drive device; and

finding a second read power (SRP) and a second gain value by increasing the first read power (FRP) value for a plurality of allowable read power values by the drive device and decreasing the maximum allowable gain value (gₘₐₓ) for the plurality of allowable gain values, the second read power (SRP) being the minimum read power value at which data is readable from the record carrier while the record carrier is rotating at a second speed allowable by the drive device.

The method is useful in all kinds of photo-detector circuits to optimize gain values and achieve optimum performance with the optimum number of gain values.

1. A method of selecting a range of gain values (2000) of a photo-detector circuit (45) for reading data from a record carrier (104), the operation of the photo-detector circuit (45) limited by an allowable gain-bandwidth product, the record carrier (104) rotatable at a plurality of allowable speeds by a drive device (100), the method (2000) comprising: finding a first read power (FRP) by setting a maximum allowable gain value (gmax) from a plurality of allowable gain values of the photo-detector circuit (45), the first read power (FRP) being a minimum read power value at which data is readable from the record carrier while the record carrier (104) is rotating at a first speed allowable by the drive device (100); and finding a second read power (SRP) and a second gain value by increasing the first read power (FRP) value for a plurality of allowable read power values by the drive device (100) and decreasing the maximum allowable gain value (gmaχ) for the plurality of allowable gain values, the second read power (SRP) being the minimum read power value at which data is readable from the record carrier while the record carrier (104) is rotating at a second speed allowable by the drive device (100).

2. The method of claim 1, wherein the second speed allowable by the drive device (100) is higher than the first speed allowable by the drive device (100).

3. The method of claim 1, wherein the second read power (SRP) and the second gain value is found on the basis of: i) the allowable gain-bandwidth product of the photo-detector circuit (45) ii) a maximum allowable read power (Rmax) for the record carrier (104) at the second speed.

4. The method of claim 1, wherein the method is performed on an optical record carrier.

5. A gain selection device for selecting a range of gain values (45H) of a photo-detector circuit (45) for reading data from a record carrier (104), the operation of the photo-detector circuit (45) limited by an allowable gain-bandwidth product, the record carrier (104) rotatable at a plurality of allowable speeds by a drive device (100), the gain selection device (45H) comprising: first read power finding means for finding a first read power (FRP) by setting a maximum allowable gain value (gmaχ) from a plurality of allowable gain values of the photo-detector circuit (45H), the first read power (FRP) being a minimum read power value at which data is readable from the record carrier while the record carrier (104) is rotating at a first speed allowable by the drive device (100); and second read power-second gain value finding means for finding a second read power (SRP) and a second gain value by increasing the first read power (FRP) value for a plurality of allowable read power values by the drive device (100) and decreasing the maximum allowable gain value (gmaχ) for the plurality of allowable gain values, the second read power (SRP) being the minimum read power value at which data is readable from the record carrier while the record carrier (104) is rotating at a second speed allowable by the drive device (100).

6. The gain selection device (45H) of claim 5, wherein the second speed allowable by the drive device (100) is higher than the first speed allowable by the drive device (100).

7. The gain selection device (45H) of claim 5, wherein the second read power-second gain value finding means further comprises means for finding the second read power (SRP) and the second gain value on the basis of: i) the allowable gain-bandwidth product of the photo-detector circuit (45) ii) a maximum allowable read power (Rmax) for the record carrier (104) at the second speed.

8. An optical pick up unit comprising the gain selection device (45H) as claimed in claim 5.

9. A drive device comprising the optical pick up unit as claimed in claim 8.

10. The drive device of claim 9, wherein the drive device is an optical drive.

11. A computer program comprising program code means for performing the method of claim 1 when said program is run on a computer.
